(19) United States
(12) Patent Application Publication
(10) Pub. No.: US 2026/0338333 A1
(43) Pub. Date: Oct. 29, 2026

(54) AUTOMATICALLY ACTIVATED SAFETY ILLUMINATION DEVICE FOR FLOOR SURFACES

(71) Applicants: Robert Wyne, Ocean City, MD (US); Rosemary Corbey, Ocean City, MD (US)

(72) Inventors: Robert Wyne, Ocean City, MD (US); Rosemary Corbey, Ocean City, MD (US)

(21) Appl. No.: 18/949,809

(22) Filed: Nov. 15, 2024

Related U.S. Application Data
(63) Continuation-in-part of application No. 18/437,951, filed on Feb. 9, 2024, now abandoned.

(51) Int. Cl. F21L 4/08; F21V 21/02; F21V 23/04; F21Y 115/10; F21Y 115/30; G09F 19/18; G09F 27/00

(52) U.S. Cl. CPC F21L 4/08; F21V 21/02; F21V 23/0407; F21V 23/0471; G09F 19/18; G09F 27/005; F21Y 2115/10; F21Y 2115/30

(57) ABSTRACT

A safety device for floor surfaces includes an enclosure with at least one side surface and a bottom surface, housing a lighting circuit with multiple illumination devices. The lighting circuit includes a controller, power source, and electric power switch. When activated, the safety device projects a light pattern onto the floor surface, which can display warning messages. The enclosure can be cone-shaped or have multiple sides, and can be freestanding or wall-mounted. The safety device can be battery-powered or plugged into a wall power outlet. Optional features include a flashing mode, sound transducer for audio alerts, and a motion sensor to activate warnings when movement is detected. The projected light pattern can be cone-shaped to cover a wide area.

### CROSS REFERENCE TO RELATED APPLICATIONS

This application is a Continuation-in-Part of U.S. patent application Ser. No. 18/437,951, filed on Feb. 9, 2024, and incorporated herein by reference.

### STATEMENT REGARDING FEDERALLY SPONSORED RESEARCH AND DEVELOPMENT

Not Applicable.

### FIELD OF THE INVENTION

This invention relates to wet floor alert devices, and more particularly to a novel wet floor device, and a quick drying cleaning solution.

### BACKGROUND

Maintaining safety in public spaces, particularly when floors are wet or slippery, is a constant challenge. Traditionally, warning signs or cones have been deployed to alert pedestrians of potential hazards. However, these static solutions have limitations in their visibility and effectiveness, especially in busy or poorly lit environments.

With the advent of rapid-drying cleaning solutions, the window of risk has shortened, but not eliminated entirely. There remains a critical period immediately after cleaning when the floor surface may still pose a slip hazard. During this time, conventional warning methods may be impractical or insufficient.

Furthermore, in situations where cleaning solutions take longer to dry due to environmental factors, there is still a need for enhanced warning systems that can complement or improve upon traditional safety cones and signs.

Therefore, there is a need for a device that provides immediate, highly visible warnings of potentially hazardous floor conditions. Such a device should be versatile enough to function in various environments and adaptable to different drying times. It should also be capable of attracting attention more effectively than static signs, especially in areas with high foot traffic or limited visibility. The present invention addresses these needs by providing an innovative, illuminated safety device designed to enhance the visibility of wet floor warnings in a variety of settings.

### SUMMARY OF THE INVENTION

The present device is a safety apparatus designed for use on floor surfaces. It consists of an enclosure with at least one side surface and a bottom surface that rests on the floor. The enclosure can be shaped as a cone or have multiple sides, for example.

Inside the enclosure is a lighting circuit that includes multiple illumination devices positioned along the side surface. The circuit also contains a controller, a power source, and an electric switch. The device can be powered by batteries or plugged into a wall outlet.

When activated, the illumination devices project a pattern of light onto the floor surface. This light pattern can display text messages such as “CAUTION” or “WET FLOOR” to warn passersby. The light pattern can be cone-shaped to cover a wide area.

The device can be freestanding or attached to a wall using various attachment mechanisms. It may feature a flashing mode to increase visibility in noisy or crowded environments.

Optional features include a sound transducer for audio alerts and a motion sensor. The motion sensor can activate both the lights and audio when it detects nearby movement, providing visual and auditory warnings. This safety device is designed to enhance awareness of potential hazards in various environments by projecting visible warnings onto floor surfaces.

The present invention addresses the drawbacks of the prior art by providing an innovative, illuminated safety device that enhances the visibility of wet floor warnings in various settings. This device offers immediate, highly visible alerts to potentially hazardous floor conditions, adapting to different environments and drying times. By projecting bright, customizable light patterns onto the floor surface, it attracts attention more effectively than static signs, especially in high-traffic areas or locations with limited visibility. The versatility of this invention allows it to complement or replace traditional warning methods, offering a dynamic solution that bridges the gap between rapid-drying cleaning technologies and the persistent need for effective safety communication in public spaces. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of a safety device of the present invention, illustrating an enclosure that is freestanding on a floor surface;

FIG. 2 is a cross-sectional view of a top portion of the enclosure through a bisecting cut line of the enclosure;

FIG. 3 is a perspective view of an alternate embodiment of the invention, illustrated with the safety device mounted to a wall and having a power cord for engaging a power outlet; and

FIG. 4 is a perspective view of the safety device and a text message in a light pattern projected onto the floor surface by the safety device.

### DETAILED DESCRIPTION

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element.

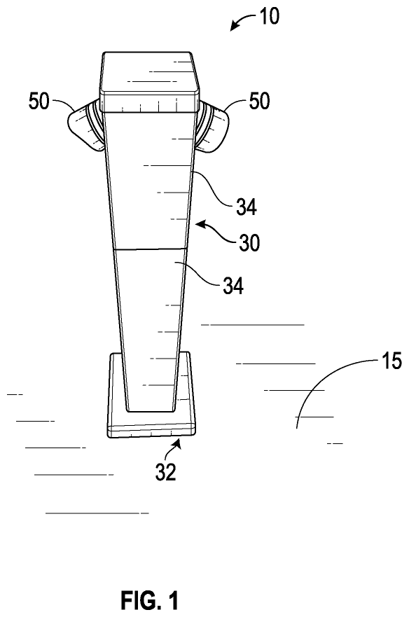

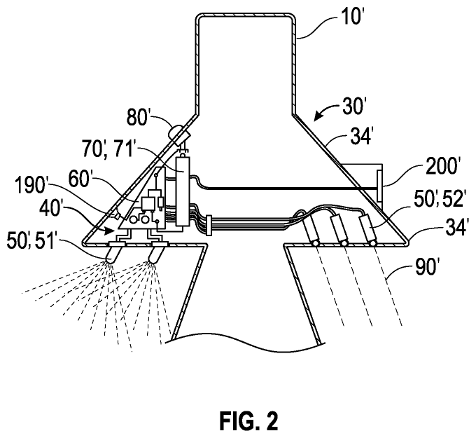

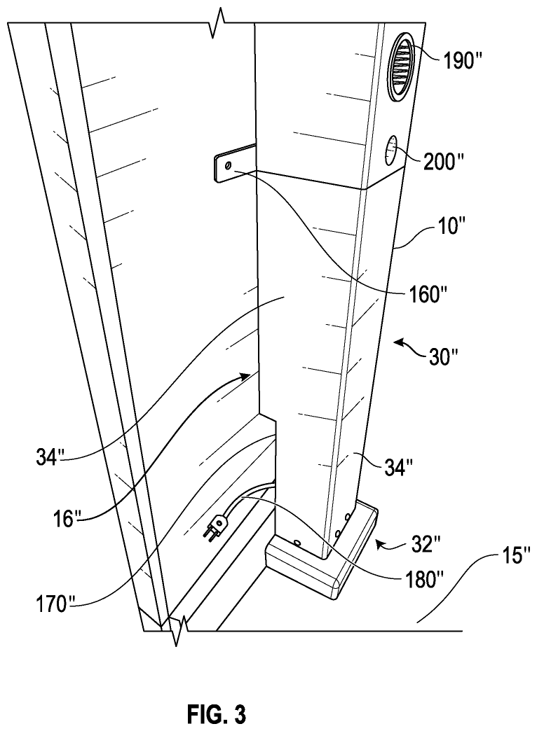

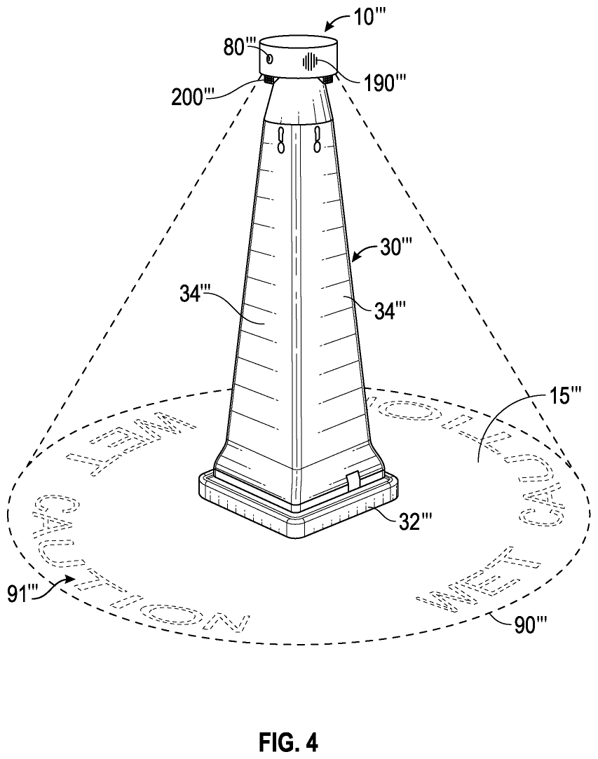

FIGS. 1-4 illustrate a safety device 10 (FIG. 1), 10′ (FIG. 2), 10″ (FIG. 3), 10″′ (FIG. 4) for use on a floor surface 15 (FIG. 1), 15″ (FIG. 3), 15″′ (FIG. 4). The safety device 10, 10′, 10″, 10′″ comprises an enclosure 30 (FIG. 1), 30′ (FIG. 2), 30″ (FIG. 3), 30″′ (FIG. 4) having at least one side surface 34 (FIG. 1), 34′ (FIG. 2), 34″ (FIG. 3), 34″′ (FIG. 4) and a bottom surface 32 (FIG. 1), 32″ (FIG. 3), 32″′ (FIG. 4). The bottom surface 32, 32″, 32″′ is adapted for resting on the floor surface 15, 15″, 15″′, and the at least one side surface 34, 34″, 34″′ rises a predetermined distance from the bottom surface 32, 32″, 32″′. The enclosure 30, 30′, 30″, 30″′ can be constructed from durable materials such as high-impact plastic, metal, reinforced polymer composites, or the like. In some embodiments the enclosure 30′ may be a cone (FIG. 2) with a single side surface 34′. In other embodiments, the enclosure 30, 30″, 30″′ may include multiple sides, such as four (FIGS. 1, 3 and 4).

A lighting circuit 40′ (FIG. 2) is fixed at least partially within the enclosure 30′. The lighting circuit 40′ includes a plurality of illumination devices 50 (FIGS. 1), 50′ (FIG. 2) at least partially traversing the at least one side surface 34, 34′. Such illumination devices 50, 50′ may include LEDs 51′ (FIG. 2), lasers 52′ (FIG. 2), fiber optic light emitters, electroluminescent panels, or the like. The lighting circuit 40′ also includes a controller circuit 60′ (FIG. 2), which can be made from a printed circuit board with microcontrollers, integrated circuits, discrete components, or the like. A power source 70′ (FIG. 2) is included in the lighting circuit 40′, which may be a rechargeable battery 71′ (FIG. 2), alkaline batteries, capacitors, fuel cells, or the like. An electric power switch 80′ (FIGS. 2), 80″′ (FIG. 4) is also part of the lighting circuit 40′, and can be a mechanical switch, touch-sensitive switch, proximity sensor, or the like. The power source 70′ of the safety device 10′ may alternatively be a conventional wall power outlet (not shown). In such cases, the enclosure 30″ may include a notch 170″ (FIG. 3) for accommodating the wall outlet and a power cord 180″ (FIG. 3) connected with the lighting circuit 40′. This configuration is shown in FIG. 3, where the safety device 10″ can be attached to the wall 16″ (FIG. 3) and plugged into a wall power outlet (not shown).

In use, with the enclosure 30, 30″, 30″′ resting on the floor surface 15, 15″, 15″′, the electric power switch 80′, 80″′ is closed to power the illumination devices 50, 50′. The illumination devices 50, 50′ project a pattern of light 90′ (FIGS. 2), 90″′ (FIG. 4) downwardly to the floor surface 15, 15″, 15″′.

The enclosure 30″ may further include a wall attachment mechanism 160″ (FIG. 3) configured for fixing the enclosure 30″ to a vertical wall 16″. Such a wall attachment mechanism 160″ can be adhesive strips, suction cups, magnetic mounts, brackets, screw mounts, or the like. This feature is illustrated in FIG. 3, which shows the safety device 10″ mounted to the wall 16″.

The pattern of light 90′, 90″′ projected by the safety device 10, 10′, 10″, 10″′ can include at least one text message 91″′ (FIG. 4) such as “CAUTION” or “WET FLOOR” to provide clear warnings to passersby. This is illustrated in FIG. 4, which shows the at least one text message 91″′ in the pattern of light 90″′ projected onto the floor surface 15′″.

As illustrated in FIG. 4, the pattern of light 90″′ can also be substantially cone-shaped to create a wide area of illumination on the floor surface 15″′. Such a cone-shaped pattern can be achieved through the use of specific lens configurations, reflectors, or arrangement of the illumination devices 50, 50′.

The lighting circuit 40′ may include a flashing mode, where the illumination devices 50, 50′ are regularly flashed on and off to draw more attention to the warning signal. This feature can be particularly useful in noisy or crowded environments where a steady light might be overlooked.

The lighting circuit 40′ may further include a sound transducer 190′ (FIGS. 2), 190″ (FIG. 3), 190″′ (FIG. 4) configured for playing an audio alert. Such a sound transducer 190′, 190″, 190″′ can be a piezoelectric speaker, dynamic speaker, electromagnetic transducer, or the like. The audio alert can be a warning chime, buzzer sound, or a prerecorded vocal message, for example.

The lighting circuit 40′ may also include a motion sensor 200′ (FIGS. 2), 200″ (FIGS. 3), 200″′ (FIG. 4) configured for activating the illumination devices 50, 50′ when the motion sensor 200′, 200″, 200′″ detects motion proximate the safety device 10, 10′, 10″, 10″′. Such a motion sensor 200′, 200″, 200″′ can be an infrared sensor, ultrasonic sensor, microwave sensor, or the like. When motion is detected, the motion sensor 200′, 200″, 200″′ can trigger both the illumination devices 50, 50′ and the audio alert from the sound transducer 190′, 190″, 190″′, providing both visual and auditory warnings.

While a particular form of the invention has been illustrated and described, it will be apparent that various modifications can be made without departing from the spirit and scope of the invention. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

1. A safety device for use on a floor surface, comprising:
an enclosure having at least one side surface and a bottom surface, the bottom surface adapted for resting on the floor surface and the at least one side surface rising a predetermined distance from the bottom surface;
a lighting circuit fixed at least partially within the enclosure, the lighting circuit including a plurality of illumination devices at least partially traversing the at least one side surface of the enclosure, a controller circuit, a power source, and an electric power switch configured for closing to power at least the illumination devices;
wherein when the bottom surface of the enclosure is resting on the floor surface with the illumination devices powered, the illumination devices are configured to project a pattern of light, including at least one text message in the pattern of light, downwardly to the floor surface such that the at least one text message in the pattern of light is shown and readable on the floor surface.

2. The safety device of claim 1 wherein the enclosure further includes a wall attachment mechanism configured for fixing the enclosure to a vertical wall.

3. The safety device of claim 1 wherein the illumination devices include at least one LED.

4. The safety device of claim 1 wherein the illumination devices include at least one laser.

5. (canceled)

6. The safety device of claim 1 wherein the pattern of light is substantially cone-shaped.

7. The safety device of claim 1 wherein the lighting circuit includes a flashing mode, wherein the illumination devices are regularly flashed on and off.

8. The safety device of claim 1 wherein the power source is a rechargeable battery.

9. The safety device of claim 1 wherein the power source is a wall power outlet, and wherein the enclosure includes a notch for accommodating the wall power outlet and a power cord connected with the lighting circuit.

10. The safety device of claim 1 wherein the lighting circuit further includes a sound transducer configured for playing an audio alert.

11. The safety device of claim 1 wherein the lighting circuit further includes a motion sensor configured for activating the illumination devices when the motion sensor detects motion proximate the safety device.

12. The safety device of claim 10 wherein the lighting circuit further includes a motion sensor configured for activating the illumination devices and the audio alert when the motion sensor detects motion proximate the safety device.

13. A safety device for use on a floor surface, comprising:
an enclosure having at least one side surface and a bottom surface, the bottom surface adapted for resting on the floor surface and the at least one side surface rising a predetermined distance from the bottom surface, the enclosure further including a wall attachment mechanism configured for fixing the enclosure to a vertical wall;
a lighting circuit fixed at least partially within the enclosure, the lighting circuit including a plurality of illumination devices at least partially traversing the at least one side surface of the enclosure, a controller circuit, a power source, and an electric power switch configured for closing to power at least the illumination devices;
wherein when the bottom surface of the enclosure is resting on the floor surface with the illumination devices powered, the illumination devices are configured to project a pattern of light, including at least one text message in the pattern of light, downwardly to the floor surface such that the at least one text message in the pattern of light is shown and readable on the floor surface.

14. (canceled)

15. (canceled)

16. A safety device for use on a floor surface, comprising:
an enclosure having at least one side surface and a bottom surface, the bottom surface adapted for resting on the floor surface and the at least one side surface rising a predetermined distance from the bottom surface;
a lighting circuit fixed at least partially within the enclosure, the lighting circuit including a plurality of illumination devices at least partially traversing the at least one side surface of the enclosure, a controller circuit, a power source, and an electric power switch configured for closing to power at least the illumination devices;
wherein when the bottom surface of the enclosure is resting on the floor surface with the illumination devices powered, the illumination devices are configured to project a pattern of light, including an indicium in the pattern of light, downwardly to the floor surface such that the indicium in the pattern of light is shown and is recognizable or readable on the floor surface, wherein the indicium in the pattern of light is at least one text message.
